(19) United States
(12) Patent Application Publication
(10) Pub. No.: US 2009/0287332 A1
(43) Pub. Date: Nov. 19, 2009

(54) SYSTEM AND METHOD FOR MANUFACTURING FULL AND PARTIAL DENTURES

(76) Inventors: Prasad Adusumilli, Parsippany, NJ (US); Stanley J. Lech, Parsippany, NJ (US)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 12/307,608

(22) PCT Filed: Jul. 2, 2007
(86) PCT No.: PCT/US07/15355

§ 371 Date: Apr. 3, 2009

Related U.S. Application Data
(60) Provisional application No. 60/818,892, filed on Jul. 6, 2006.

(51) Int. Cl. G06F 19/00; G06F 17/50; A61C 3/00; A61C 8/00

(52) U.S. Cl. 700/98; 700/118; 700/120

(57) ABSTRACT

There is provided a system for fabricating at least a portion of a denture. The system includes a three-dimensional scanning device for scanning a surface of a denture template, and a computer-readable medium including a computer program for receiving data from the scanning device, creating a 3-dimensional model of the surface, and optionally modifying the 3-dimensional model and/or adding features to the 3-dimensional model. The system also includes a fabricator for creating the at least the portion of the denture, from a selected material, based on the 3-dimensional model. The fabricator may be a device including a lathe, or a rapid prototyping machine. There is also provided a method for fabricating at least a portion of a denture.

### BACKGROUND OF THE INVENTION

1. Field of the Invention

The present invention relates to medical manufacturing. More particularly, the present invention relates to advanced manufacture of full and partial dentures using rapid prototype technologies.

2. Description of the Related Art

Current processes for manufacturing dentures involve taking an impression of the palate or other parts of the oral cavity with a material such as an alginate paste, making a wax model, manually placing teeth in the wax model, and replacing the wax with acrylic polymers. This process is very cumbersome, generally involves several attempts, and generally takes two to six weeks. The resulting denture is neither user friendly nor is it customizable. Also, the resulting denture encounters frequent problems including sore spots, lack of hold and retention, and bacterial growth that may lead to malodor and associated health problems.

Rapid prototyping machines are employed for various uses such as concept modeling, manufacturing of samples or prototypes of various components and products such as machine components, and for biological models of bones and blood vessels. These technologies are currently marketed for rapid prototype development, such as those commercially available from 3D systems, Stratasys, Arcam, solidscape, Roland, EOS, Envisiontech, Belcam, Objet and Zcorp. Rapid prototyping machines, however, have not been used to manufacture dentures, or specifically customizable dentures.

There is a need for a method and apparatus for manufacture of full or partial dentures that is quick and accurate, and can be manufactured individually for a customer by a service provider such as a dentist.

There is also a need for a method and apparatus for manufacture of full or partial dentures that utilizes rapid prototyping machines.

There is also a need for a method and apparatus for manufacture of full or partial dentures that allows for customization during the manufacturing process.

There is a further need for a method and apparatus for manufacture of full or partial dentures that can produce dentures that fit exactly for any given patient, and can allow for including customized features in the denture during the manufacturing process to improve the fit and comfort to the patient.

### SUMMARY OF THE INVENTION

There is provided a system for fabricating at least a portion of a denture. The system includes a three-dimensional scanning device for scanning a surface of a denture template, a computer-readable medium including a computer program for receiving data from the scanning device and creating a 3-dimensional model of the surface, and a fabricator for creating at least a portion of the denture, from a selected material, based on the 3-dimensional model. The scanning device may directly scan portions of the upper or lower palate, or scan an impression or model of the upper and/or lower palate. The palate includes the gum line, musculature and tissue surrounding the gum line, and tissue forming the arch or areas between the gum line. The fabricator may be a device including a lathe, or a rapid prototyping machine. There is also provided a method for fabricating at least a portion of a denture.

### BRIEF DESCRIPTION OF THE DRAWINGS

FIG. 1 is a block diagram of a system of the present invention.

FIG. 2 is an interior view of an embodiment of a scanner in which a physical model of a patient's gum line and palate is positioned.

FIG. 3 is an interior view of an embodiment of the scanner of FIG. 2 in which a model of a pre-existing denture is positioned.

FIG. 4 is an exterior view of a display of a 3D image of a denture template and an exterior of the scanner of FIG. 2.

FIG. 5A is a top view of an image of the physical model of FIG. 2, and FIG. 5B is a bottom view of the image of the physical model of FIG. 2.

FIG. 6A is a front view of an image of the model of FIG. 3, FIG. 6B is a top view of the image of the model of FIG. 3, and FIG. 6C is a bottom view of the image of the model of FIG. 3.

FIG. 7 is a view of a milling machine.

FIG. 8 is a close-up view of the milling machine of FIG. 7.

FIG. 9 is a close-up view of a denture created in the milling machine of FIG. 7.

### DESCRIPTION OF THE INVENTION

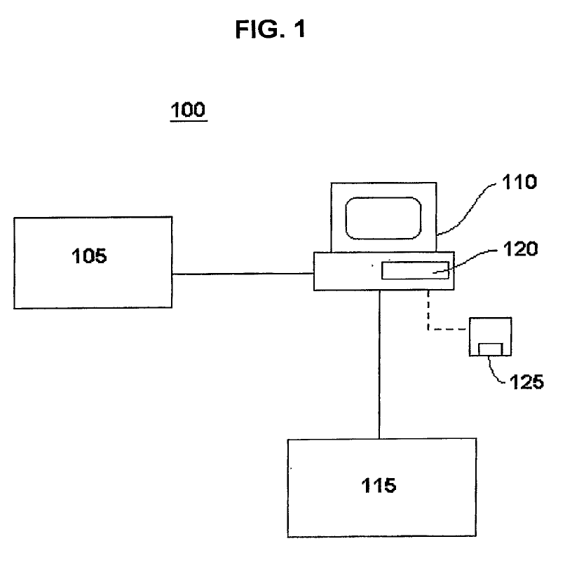

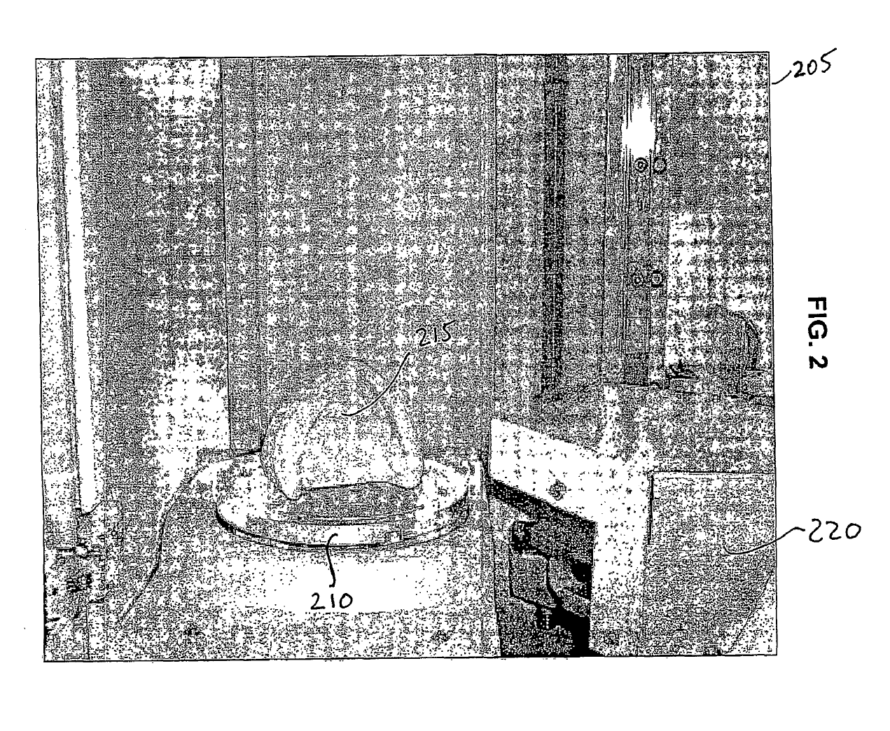

Referring to the drawings, and in particular FIG. 1, there is shown a system generally represented by reference numeral 100. System 100 that includes a scanning device 105 connected to computer 110. System 100 also includes a fabricating machine, i.e., fabricator 115, which is preferably connected to computer 110. Scanning device 105 may alternatively include its own processor and interface integrated with scanning device 105, or may be connected to a processor as shown in FIG. 1. Also, fabricator 115 may not be directly connected to computer 110 or scanning device 105. Data retrieved from scanning device 105 may be stored in a separate memory and transferred to fabricator 115.

Scanning device, i.e., scanner 105, is a 3-dimensional (3D) scanner that preferably uses an optical source to take data representing the shape of the denture template. Scanner 105 may be configured to measure the shape of any portion of the denture template. The denture template includes all or part of the patient's buccal cavity, including the upper and lower gum lines, the upper and lower arches, and the palate. The denture template may also be a cast or other physical model of one or more portions of the patient's buccal cavity. The denture template may also be a pre-existing denture or physical model of a denture that can be scanned for manufacturing copies of the denture, or customized versions of the denture.

In one embodiment, scanner 105 is an infrared camera designed to mimic the shape of the gum line such that it can capture the contour of the entire upper or lower gum line. The infra red camera is used to scan, e.g., the entire buccal cavity and capture the image of the upper or lower arch, either sequentially or simultaneously. The camera may also be made to work with ultrasound, radio waves, radar, soft X-ray, MRI and CAT scan technologies. Scanner 105 may also scan a cast or model of the gums and/or palate.

Computer 110 may be a stand alone processor such as a personal computer having inputs and a display. Computer 110 may also be a processor incorporated in scanner 105 or fabricator 115. Computer 110 incorporates software that creates a 3D image from data provided by scanner 105. The software, which is preferably stored in memory 120, is a modeling program. Preferably, the software is a computer-aided drafting (CAD) program. The software will capture the 3D image and calculate all the dimensions of the denture template, allow a user to make any modifications such as adjusting the gum line or inserting teeth and, when the user is satisfied, transfer the image to fabricator 115.

The software is not limited to CAD programs. Any suitable software may be created using various languages such as C++, Java, Basic, Pascal, and any other suitable languages. The resulting software may be in any form capable of receiving a scanned image, modifying that image, and sending data representative of the image to fabricator 115.

Although system 100 is described herein as having the instructions for the method of the present invention installed into memory 120, the instructions can reside on an external storage media 125 for subsequent loading into memory 120. Storage media 125 can be any conventional storage media, including, but not limited to, a floppy disk, a compact disk, a magnetic tape, a read only memory, or an optical storage media. Storage media 125 could also be a random access memory, or other type of electronic storage, located on a remote storage system and coupled to memory 120.

Fabricator 115 is preferably a rapid prototyping machine. The rapid prototyping machine may include an industrial machine similar to a lathe and controlled by appropriate software. The lathe shapes a starting material, such as an acrylic block, to a desired shape. The lathe is designed to accept instructions from computer 110 and cut a material, such as a flat U shaped acrylic disk, to resemble the upper and lower gum lines and palates as needed to mimic the dentures, as they are currently worn by a user. The lathe may be used to mark out the teeth, or an area for teeth can be cut out and pre-existing teeth can be inserted in to cavities and glued to hold in place.

Material used to create the denture with fabricator 115 may be a denture polymer that could be composed of any non-toxic, curable, non-water-soluble plastic polymer, such as acrylic (PMMA), nylon, polycarbonate, ABS plastic, urethane dimethacrylate/acrylic copolymer, and butadiene-styrene rubber. Acrylic is a preferred polymer for making dentures. However, any hard plastic with similar properties to acrylic polymer would be suitable.

There are several rapid prototyping machines employing several different technologies that can be provided as fabricator 115 and used for fabrication of full and partial dentures. Such rapid prototyping machines include stereo lithography, laser-sintering, multi-jet modeling, fused deposition modeling, electron beam melting and 3D printing machines.

Stereo Lithography (SLA) is a method that utilizes liquid plastic and a laser. The SLA machine's laser “paints” one of a plurality of layers of liquid plastic by exposing selected areas of the liquid plastic layer in a tank to radiation and hardening it. This process continues for each layer until all the layers are built. A manifold is then raised to exposing the model. This model is then washed with appropriate solvents and cured in a UV chamber to complete the manufacturing process.

Laser sintering systems, such as selective laser sintering (SLS) systems, use a high power laser to melt and fuse particles of powder and build one layer at a time until the complete model is built. The powder may be made from plastic polymers, metal particles or combinations thereof as desired.

Multi-jet Modeling (MJM) machines use a wide area head with multiple spray nozzles. These jetting heads spray tiny droplets of molten liquid material which cool and harden on impact to form a layer. This process is repeated to produce multiple layers until an entire object is built.

Fused Deposition Modeling (FDM) is a process in which a thermoplastic polymer is heated and the molten polymer is deposited at precise locations and allowed to cool and harden, to build one layer at a time until an object is constructed.

Electron Beam Melting (EBM) uses a beam of electrons to melt metal or plastic particles at precise locations and fuse them in place to form a layer, and repeating this process to build a complete object.

3D printing machines spray ink and adhesives, and some inks containing adhesives, using standard ink-jet technology, to glue particles at precise locations on a substrate, thus creating a layer. The process is repeated to build multiple layers that make up a complete object. In another embodiment, the 3D printing process may include the use of monomers as adhesives. For example, a polymer such as PMMA may be used as the ink forming each layer, and a monomer may be used as an adhesive layer. The PMMA and/or monomer solutions may be colored and used as the ink and adhesive, respectively.

Laser sintering and electron beam melting processes can be used to build prostheses that contain both plastic and metal, such as dentures with metal inserts and partial dentures.

3D printing may also be used for fabrication of teeth integrated with the denture during a single manufacturing process. When other rapid prototyping machines are used, the cavities for later placement of teeth will be built in to the base plate. Teeth are then glued in to the base plate manually using appropriate glue. Suitable glue for attaching teeth to the base plate can be molten polymethyl methacrylate or any other suitable plastic polymer.

In addition, technologies such as FDM and MJM can be modified to produce prototypes with multiple colors via using either single or multiple depositing heads. In such case, these technologies can be used for fabrication of the denture with teeth in place.

There is provided a method for manufacturing full or partial dentures utilizing the system described above. The method generally includes 1) an optional first step of providing or making a physical model of at least a portion of a patient's oral cavity, such as providing a pre-existing denture, taking an impression of at least a portion of the patient's oral cavity and/or making a cast of an impression of at least a portion of the patient's oral cavity. The denture template as described above therefore may include portions or the entirety of the patient's oral cavity, and physical models of at least a portion of the patient's oral cavity. The method also includes 2) scanning the denture template, i.e., directly scanning the oral cavity or a physical model thereof, 3) developing a 3D computer model of the denture template, 4) optionally modifying the 3D model, and 5) manufacturing the full or partial denture based on the 3D model in a rapid prototyping machine.

In the first optional step, an impression, model or cast of the gum line and/or palate is taken. In one embodiment, a soft pliable plastic disk having a U-shape, or general shape of a buccal cavity, is inserted into the buccal cavity. The disk may be made of a suitable plastic material such as soft nylon, polypropylene, polyethylene or acrylic. A non-dissolvable clay disk may be used instead of the plastic disk. The patient then bites into the disk. The disk deforms according to the contour of the upper and lower gum lines and upper and lower palates. The finished model is then removed from the mouth and placed on a 3D scanner, which then scans the contours of the upper and lower gum lines and palates.

In the scanning step, a user such as a dentist uses scanner 105 to take a scan of the oral cavity, and this scan is transferred automatically to computer 110. The scan can be obtained by a variety of methods. In one method, an infrared camera, designed to mimic the shape of the gum line, is positioned in or near the oral cavity. The camera is preferably designed to capture the contour of the entire upper and/or lower gum line by receiving reflected infrared radiation. To help the camera register the image, a spray, paste or a mouthwash that is reflective of infrared radiation may be applied to the upper or lower gum line prior to scanning. The infra red camera then scans the entire buccal cavity and captures the image of the upper or lower arch. In another embodiment, the camera may capture images of both the upper and lower gum line simultaneously.

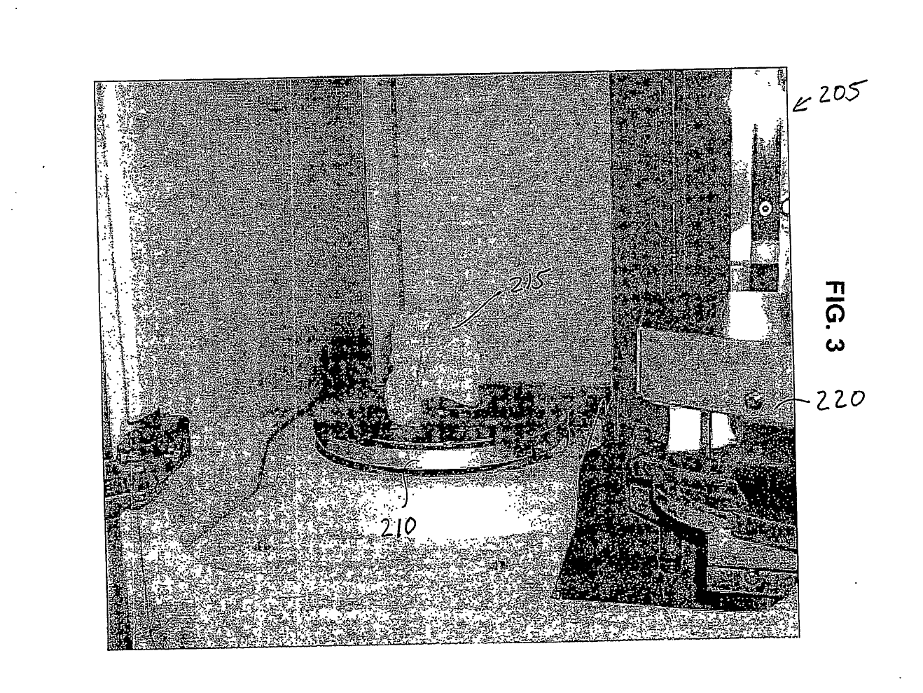

In another embodiment of the scanning step, a model or cast of the gum line and/or palate, or a pre-existing denture, is scanned by scanner 105 instead of directly scanning the oral cavity. This embodiment is shown in FIGS. 2-4.

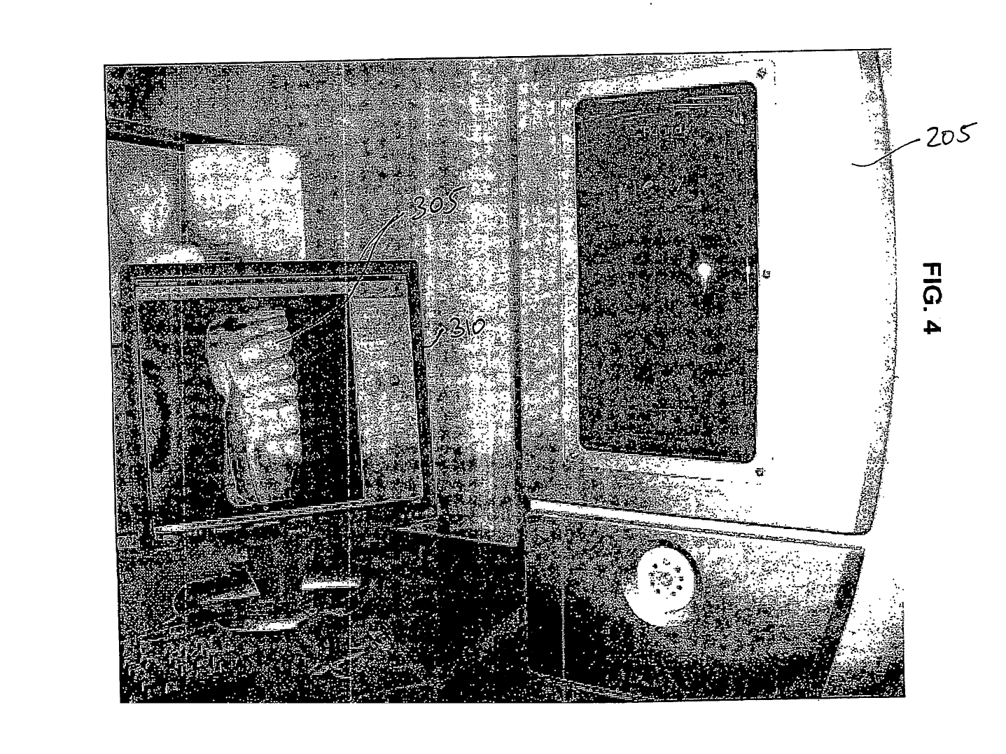

FIG. 2 shows an interior of an embodiment of a scanner 205, including a platform 210 and a scanning unit 220. A model 215 of a patient's gum line and palate is positioned on platform 210. In this embodiment, model 215 represents the lower palate, however, model 215 may also be a model of the upper palate. Upon activation, a scanning unit 220, located inside scanner 105 exposes selected surfaces of model 215 to laser radiation. Reflected radiation from the surfaces of model 215 is captured by scanning unit 220. Platform 210 also rotates model 215, and scanning unit 220 scans model 215 at a variety of different angles. These various scan results are then put together by the software to create a 3D image. FIG. 3 shows the interior of scanner 205, where model 215 is a pre-existing denture or a cast of the upper palate of a patient, including the teeth.

The results of the next step are shown in FIG. 4. Computer 110 receives data from scanner 205, and CAD software located in memory 120 creates a 3D image 305. 3D image 305 is shown as displayed on display 310. FIG. 4 also shows an exterior of scanner 205.

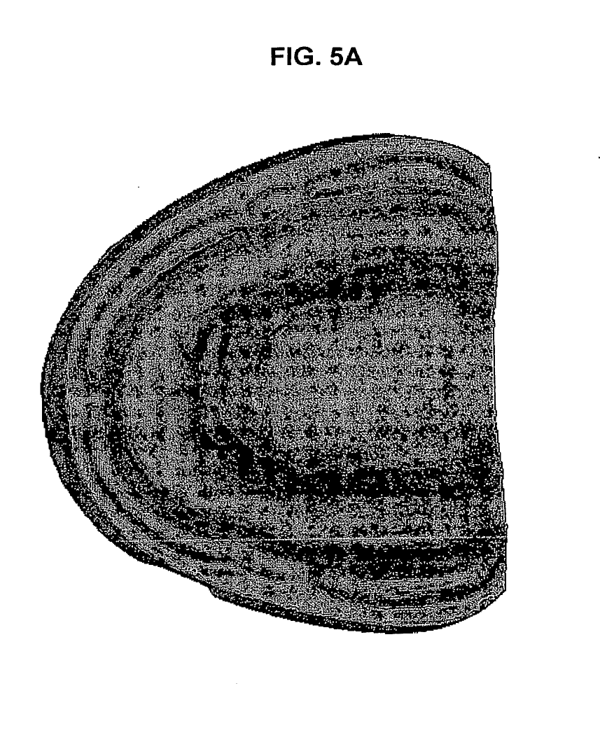

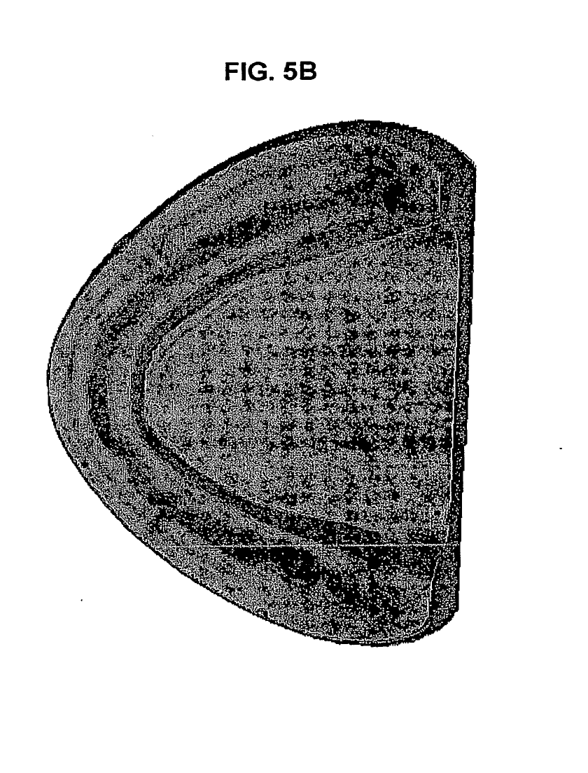

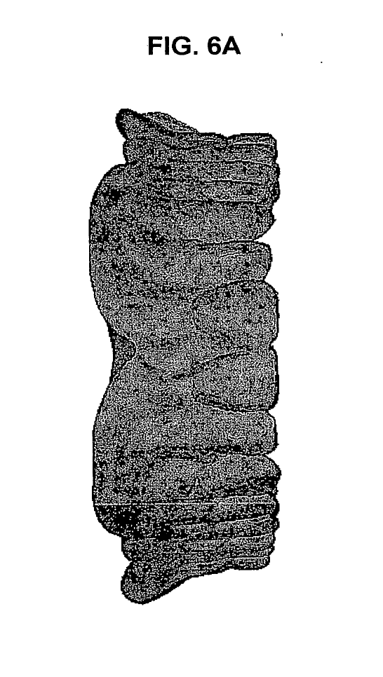

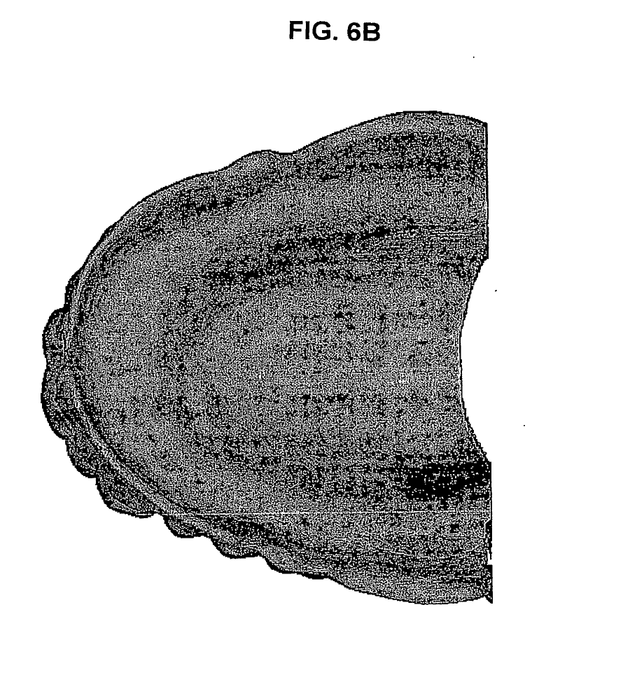

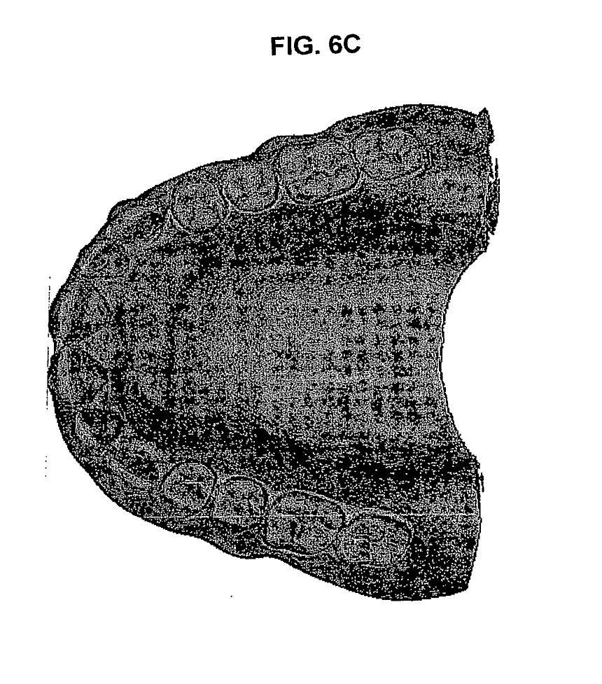

FIGS. 5A, 5B, 6A, 6B and 6C show examples of an image as produced by the scanned software. This image is a 3D image that can be viewed from any angle via the CAD software. FIG. 5A is a top view of an image of model 215, showing the upper cast of a patient's palate and gum line, and FIG. 5B is a bottom view of an image of model 215, showing the lower cast of the patient's palate and gum line.

FIGS. 6A through 6C show an example of image 305 as taken of a pre-existing denture. FIG. 6A is a front view of image 305, FIG. 6B is a top view of image 305, and FIG. 6C is a bottom view of image 305.

The software then calculates all the dimensions of the upper and lower gum lines and palates. The dimensions are then transferred to fabricator 115. The dimensions may be automatically transferred to fabricator 115, or transferred to fabricator 115 at the command of a user.

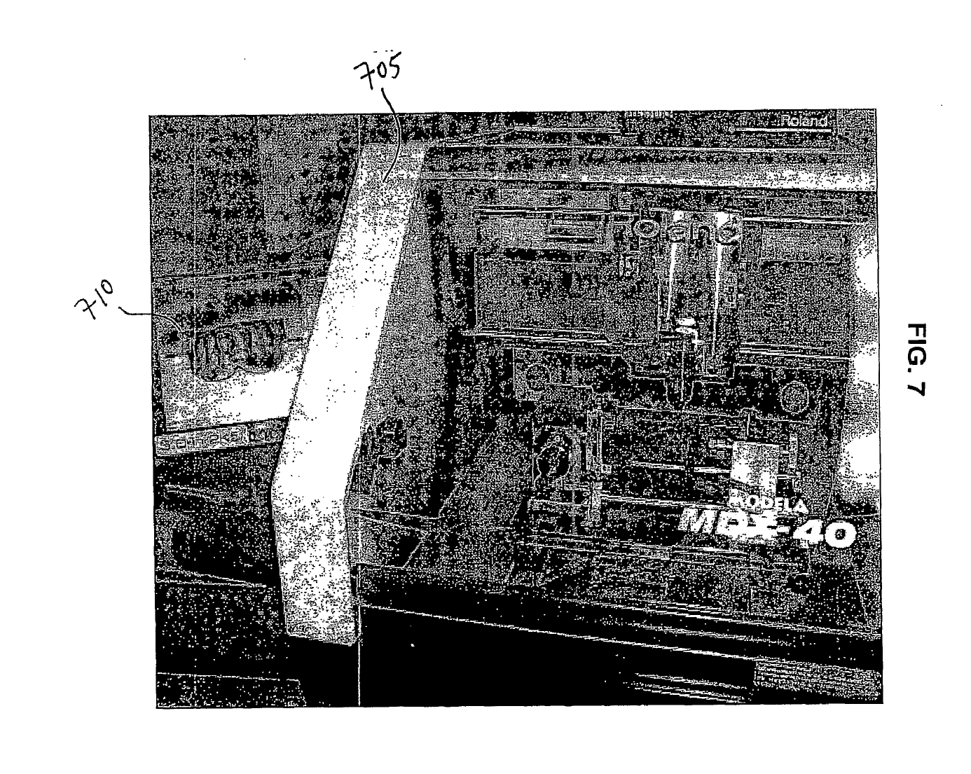

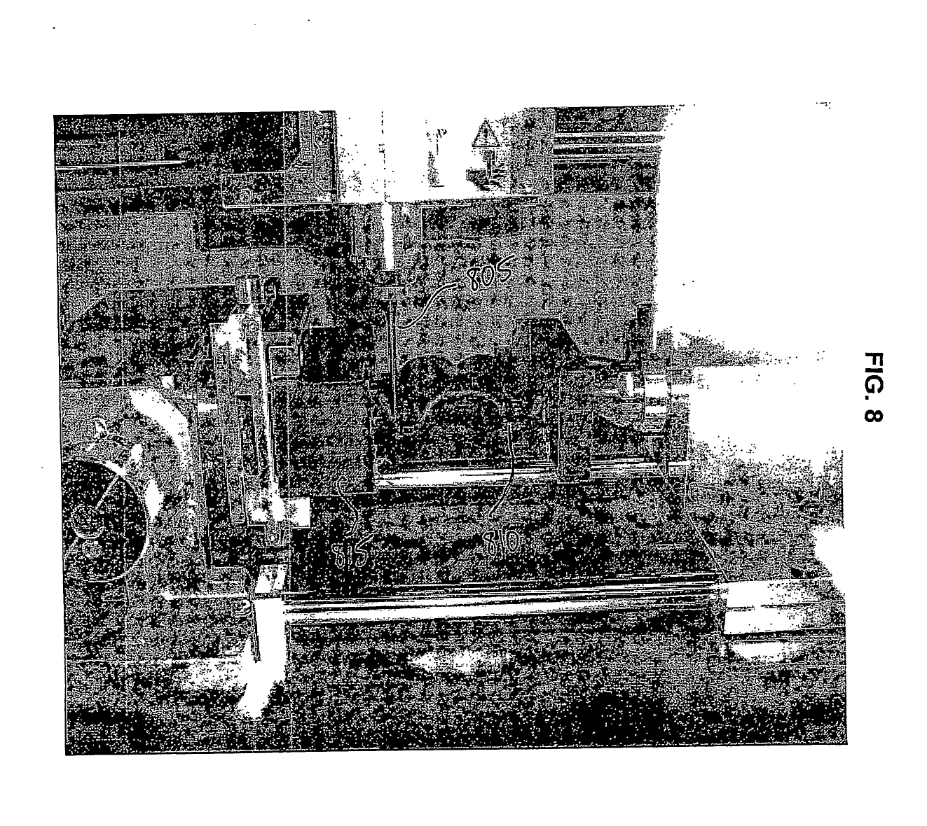

An embodiment of fabricator 115 is shown in FIGS. 7 and 8. FIG. 7 shows milling machine 705 carving a denture based on scanned image data. FIG. 7 also shows a displayed CAD image 710 created from data received from scanner 105. Milling machine 705 accepts instructions from computer 110.

As shown in FIG. 8, milling machine 705 includes a lathe 805. Based on instructions from computer 110, milling machine 705 controls lathe 805 to cut a denture 810 from block 815. Milling machine 705 cuts block 805 to resemble the upper and lower gum lines and palates as needed to mimic the dentures, as they are currently worn by a user.

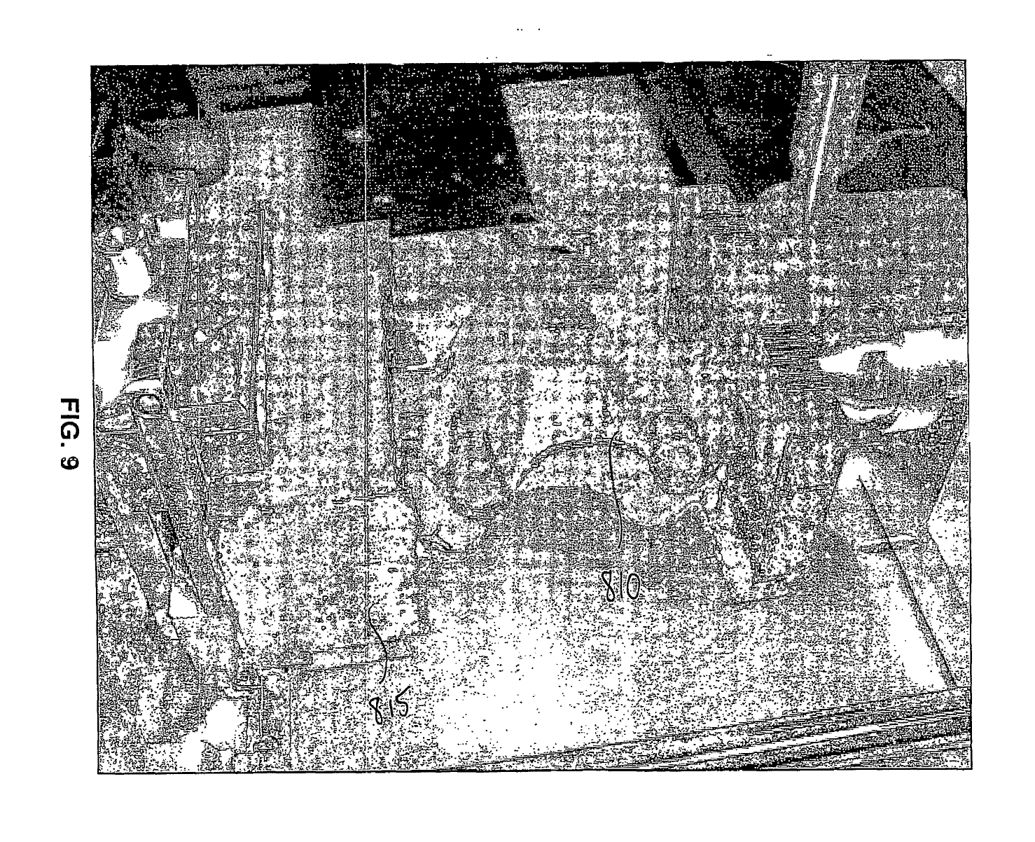

FIG. 9 is a close-up of denture 810 as cut from block 815 to replicate the image provided by the CAD software in computer 110. Prior to the step of forming denture 810, the image taken from scanner 105 may be modified by the user according to the user's specific needs. For example, various modifications may be accomplished such as changing the height of the denture, changing the surface contours of the palate, changing the gum line, and inserting various teeth. Thus, although the finished denture replicates the 3-dimensional image in the CAD software, the finished denture may not exactly replicate the model or oral cavity initially scanned. The user and/or patient may view the scanned image and determine which modifications should be incorporated. Furthermore, the user and/or patient may preview each modification before finalizing the image and sending the image to fabricator 115.

Denture 810 is then further processed to mark out the teeth and process this area such that the teeth are white in color, where as the rest of the denture is pink in color to resemble oral tissue. The area occupied by the teeth in denture 810 may be bleached using hydrogen peroxide or other suitable oxidizers to define teeth. In an alternative embodiment, the teeth areas of denture 810 may simply be coated with white or off white colors to create teeth. In yet another embodiment, cavities for teeth may be cut out and teeth that are currently marketed may be inserted into the cavities and glued to hold in place.

Using the above method, a suitable acrylic polymer or any other suitable plastic polymers or mixtures there of can be used to produce a final prosthesis with desired characteristics. The composition of the polymeric blend can be formulated such that the polymerization reaction can be initiated at room temperature by a chemical reaction or heat or light.

Dentures fabricated with the above systems and methods may have many new features that aid in fit and comfort to the patient. Such features may be fabricated during customization of the dentures, particularly during processing of the scanned CAD image.

Clip-on dentures may be manufactured that do not include a palate. The upper and lower dentures have built-in clips designed to go around the gum line and hold the dentures in place. Also, the upper denture will not have the palate, which is required in the conventional denture to provide suction and hold. Such a design is advantageous, in that traditional palates are a major cause of food entrapment and provide porous surfaces for bacterial growth which leads to malodor and other health complications. Removal of this palate from the dentures eliminates these complications, making the dentures much more user friendly.

Optionally, the gum area may have suction cups, which can enhance the hold and retention of the dentures. These suction cups will also provide a cushioning effect, when people are chewing food. Such effect will enhance the comfort for the patient. In another optional embodiment, an arch will be built on the back of the upper denture to provide additional stability for the denture, if so desired.

In another optional embodiment, the upper and/or lower denture will have a small chamber big enough hold a strip or a caplet in place. This caplet or a strip may contain medicaments and release the same over a period of 2 to 24 hrs to kill germs, reduce plaque and freshen breath.

In a further embodiment, a number of spaces may be formed in the palate, preferably on the arch area between the gum lines. These open spaces form a plurality of passageways between surfaces of the oral cavity and the interior of the oral cavity. Such spaces may be in any configuration such as a cross-hatch pattern or a plurality of holes. The spaces allow food to contact the palate so that a user can experience the taste and texture of the food while retaining the denture.

The features discussed above are designed into the denture during the manufacturing process. Specifically, the clips, suction cups, chamber and/or spaces are incorporated into the computer image, using the CAD software, after scanning. The finished denture is then created by fabricator 115 as a single monolithic piece that includes the features.

Various fabrication methods allow for the inclusion of a variety of materials to improve the performance of the manufactured dentures. For example, dentures may be manufactured to include bio-adhesive materials. These materials, included in selected external portions of the denture, naturally adhere to the buccal membranes and in turn provide better adhesion to improve the holding power of the denture and may also eliminate the need for denture adhesives or suction cups.

Dentures may also be manufactured with anti-microbial agents built into the material used to manufacture the denture, such as a polymer matrix. For example, an acrylic block used to fabricate the dentures can be manufactured with a desired concentration of anti-microbial agents dissolved into the plastic. In such a case, the anti-microbial would slowly leach from the plastic over a long period of time and prevent bacterial growth on the surface of the dentures to eliminate malodor and all the associated health risks with bacterial growth. In addition, it may also kill pathogenic bacteria in the oral cavity. The length of anti-microbial efficacy can be controlled by the amount of the ingredient incorporated into the plastic and by controlling the release rates via adjusting the composition of the plastic. The duration of anti-microbial efficacy can range from a month to a year or more, providing excellent convenience and hygiene to the patient.

The denture polymer could be composed of any non-toxic, curable, non-water-soluble polymer, capable of adhering to the denture surface. Antimicrobial agent(s) would be imbedded in the cured polymer matrix and, would leach-out over time thus creating a hostile environment for microorganisms on the surface of the denture material and potentially in the buccal cavity for an extended period of time.

The antimicrobials used may include, but are not limited to, the following compounds: cetylpyridinium chloride, chlorhexidine, benzethonium chloride, triclosan, thymol, sorbic acid and its salts, benzoic acid and its salts, Nystatin, ketoconazole, and miconizole and its salts.

The methods and apparatus described herein offer many advantages. These advantages include rapid construction of the denture prosthesis, typically in about 2 hours, in contrast to prior art processes that can takes as much as 8 hours to about 6 weeks to complete.

Another advantage is that the method and apparatus allows the dentist, or other user, as well as the patient intended for the denture, to see an image of the patient with the prosthesis in place and make any necessary changes to the design of the unit prior to construction. Such changes include adjust vertical dimensions, evaluating the aesthetics of various sizes, shapes and colors of teeth, effect of neutral zone, correct lip pull, etc.

The method and apparatus would, for denture wearers, provide more user friendly dentures, made to fit the precise contours of the buccal cavity. The dentures can be made very quickly in a dental office, and can be completed in one visit to the dentist's office. The dentures also provide better hold, more comfort and functionality, and can be designed to reduce or eliminate odors.

In turn, this would lead to an overall improvement of a patients' oral hygiene, thus helping to alleviate some of the hygiene problems and disease states associated with wearing dentures which include the following: food entrapment and putrification, denture plaque formation, increased denture staining, oral malodor, oral candidosis, damage to existing natural and artificial (implant) teeth, and other oral bacterial infections.

It should be understood that various alternatives, combinations and modifications of the teachings described herein could be devised by those skilled in the art. The present invention is intended to embrace all such alternatives, modifications and variances that fall within the scope of the appended claims.

What is claimed is:

1. A system for fabricating at least a portion of a denture, comprising:
a three-dimensional scanning device for scanning a surface of a denture template;
a computer-readable medium including a computer program for receiving data from said scanning device and creating a 3-dimensional model of said surface; and
a fabricator for creating at least a portion of said denture, from a selected material, based on said 3-dimensional model.

2. The system of claim 1, wherein said denture template is selected from the group essentially consisting of a physical model of at least a portion of a patient's oral cavity, and a pre-existing denture.

3. The system of claim 1, wherein said denture template is selected from the group essentially consisting of a buccal cavity, upper and lower gum lines, upper and lower arches, and a palate.

4. The system of claim 1, wherein said computer-readable medium is operatively connected to a processor, and wherein said processor is incorporated in a location selected from the group consisting of an independent computer, said scanning device, and said fabricator.

5. The system of claim 1, wherein said scanning device includes an optical source to take data representing a shape of said denture template.

6. The system of claim 1, wherein said scanning device is selected from the group consisting of an infrared camera, an ultrasound device, a radio wave device, radar, soft X-ray, magnetic resonance imaging (MRI), and a CAT (Computed Axial Tomography) scan device.

7. The system of claim 1, wherein said computer program is a computer-aided drafting (CAD) program.

8. The system of claim 1, wherein said fabricator includes a lathe for shaping a material to create said portion of said denture.

9. The system of claim 1, wherein said fabricator is a rapid prototyping machine.

10. The system of claim 8, wherein said rapid prototyping machine is selected from the group essentially consisting of a stereo lithography machine, a laser-sintering machine, a multi-jet modeling machine, a fused deposition modeling machine, an electron beam melting machine, and a 3D printing machine.

11. A method for fabricating at least a portion of a denture, comprising:
scanning a surface of a denture template using a three-dimensional scanning device;
receiving data from said scanning device and developing a 3-dimensional computer model of said surface based on said data; and
creating at least a portion of said denture, based on said 3-dimensional model.

12. The method of claim 11, further comprising modifying said 3-dimensional computer model based on a patient's specifications, prior to creating said portion of said denture.

13. The method of claim 11, wherein said scanning includes positioning a camera proximate to a patient's oral cavity, and capturing an image of at least a portion of said oral cavity.

14. The system of claim 11, wherein said denture template is selected from the group consisting of: at least a portion of a patient's oral cavity, a physical model of at least a portion of a patient's oral cavity, and a pre-existing denture.

15. The method of claim 11, wherein said step of creating said at least said portion of said denture includes transmitting data from said 3-dimensional computer model to a fabricator, and wherein said fabricator is selected from the group consisting of a lathe and a rapid prototyping machine.

16. The method of claim 15, wherein said rapid prototyping machine is selected from the group essentially consisting of a stereo lithography machine, a laser-sintering machine, a multi-jet modeling machine, a fused deposition modeling machine, an electron beam melting machine and a 3D printing machine.

17. The method of claim 15, wherein said fabricator creates said portion of said denture from a material selected from the group essentially consisting of metal, plastic polymer, acrylic (PMMA), polycarbonate, ABS plastic, nylon, urethane dimethacrylate/acrylic copolymer, and butadiene-styrene rubber, and any combinations thereof.

18. The method of claim 12, wherein said step of modifying said computer model includes modifications selected from the group essentially consisting of adjusting a shape of the image, adjusting a size of the image, and/or incorporating features not existing in said denture template, and wherein said features are created by said fabricator as an integrated part of said portion of said denture.

19. The method of claim 18, wherein said features are selected from the group essentially consisting of clips to hold said at least said portion of said denture in place, suction cups, an arch to provide additional stability for the denture, open spaces between surfaces of said denture, and a chamber inside said at least said portion of said denture.

20. The method of claim 17, wherein said material includes substances incorporated therein, selected from the group essentially consisting of bio-adhesive materials and anti-microbial agents.

21. The method of claim 12, further comprising displaying said 3-dimensional computer model to said patient to allow said patient to select and view said specifications.
